(19) United States
(12) Patent Application Publication
(10) Pub. No.: US 2013/0339836 A1
(43) Pub. Date: Dec. 19, 2013

(54) Compliance Verification Using Field Monitoring in a Computing Environment

(71) Applicants: Tal Drory, Haifa (IL); Amir Geva, Yokneam (IL); Asaf Tzadok, Nesher (IL); Eugene Walach, Haifa (IL)

(72) Inventors: Tal Drory, Haifa (IL); Amir Geva, Yokneam (IL); Asaf Tzadok, Nesher (IL); Eugene Walach, Haifa (IL)

(73) Assignee: International Business Machines Corporation, Armonk, NY (US)

(21) Appl. No.: 13/517,629

(22) Filed: Jun. 14, 2012

(51) Int. Cl. G06F 17/24

(52) U.S. Cl. 715/224

(57) ABSTRACT

Systems and methods for enforcing compliance in a computing environment, the method comprising concurrently and independently executing a monitoring application with a first application utilized by a user, wherein navigating beyond a first decision point in the first application requires the user considering values associated with one or more elements in the first application, wherein the monitoring application monitors elements presented to the user to determine which elements are presented to the user at a point in time; and notifying the user of at least a first element, in response to not having been able to confirm whether a value associated with the first element has been considered by the user prior to said first decision point.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to compliance verification using independent field monitoring in a computing environment and, more particularly but not exclusively, to a system and method for ensuring that a user has reviewed certain data fields while using a computing application before a point of decision making.

### BACKGROUND

In structured decision making environments, people with limited authority may be required to comply with certain rules and procedures before approving an item or making a decision. For example, a manager prior to approving the payment of a bill may be required to review the data in the billing statement to make sure that the bill has been submitted within a certain time period from the date of service, identify whether the biller is within the list of approved billers, and whether the amount of the bill is within an approved range.

In the above mentioned environments, software applications may be utilized or implemented to run on computing systems to help automate some of the tasks related to calculating whether certain dates or amounts fall within preapproved ranges, as a part of facilitating the decision making and review process. Generally, if the value entered into a field does not meet the compliance requirements, the user may be notified that the entered value is unacceptable and require the user to reenter the information.

The above approach is often disruptive and cumbersome because it slows down or completely interrupts the user's process execution. The main reason for such disruption is that most monitoring and verification applications generally do not provide sufficient flexibility for the user to skip over a field for which the user may not know the value at the time, or that the verification process is dependent on a rigid and structured path of execution, so that the user is forced to follow that path, as opposed to having the freedom to follow a more natural path depending on the user's preference or convenience.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, systems and methods for enforcing compliance in a computing environment are provided. In one embodiment, the method comprises concurrently and independently executing a monitoring application with a first application utilized by a user, wherein navigating beyond a first decision point in the first application requires the user considering values associated with one or more elements in the first application, wherein the monitoring application monitors elements presented to the user to determine which elements are presented to the user at a point in time; and notifying the user of at least a first element, in response to not having been able to confirm whether a value associated with the first element has been considered by the user prior to said first decision point.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary operation environment in accordance with one or more embodiments, wherein a software application running on a computing system is monitored for compliance.

FIG. 2 is an exemplary flow diagram of a method of monitoring field values for compliance in a computing environment, in accordance with one embodiment.

FIG. 3 is an exemplary block diagram of a user interface being monitored for compliance, in accordance with one embodiment.

FIGS. 4A and 4B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

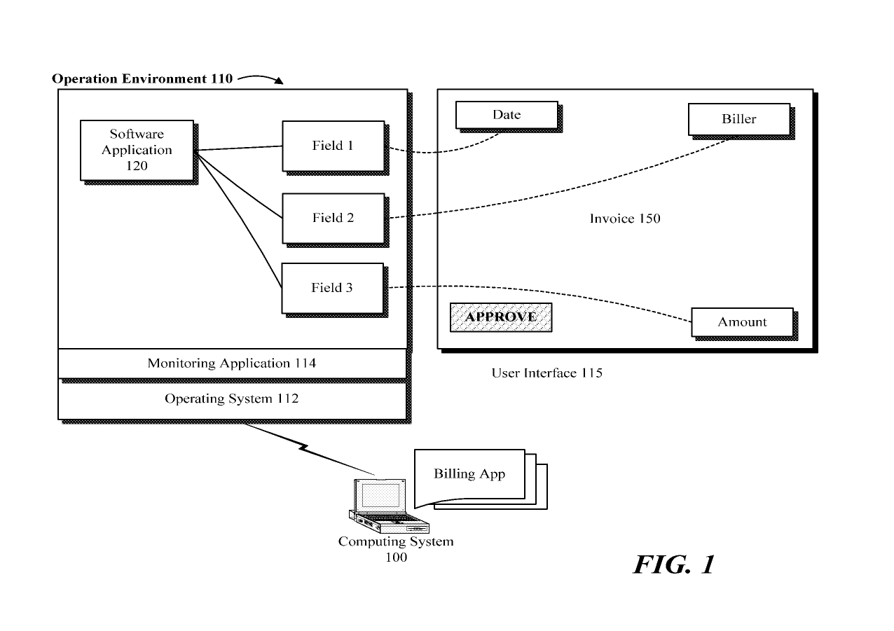

Referring to FIG. 1, an exemplary operating environment 110 is illustrated in which a monitoring application 114 is executed on top of an operating system 112 loaded onto a computing system 100. In accordance with one aspect, operation environment 110 supports a multiprocessing environment in which a software application 120 can be executed on top of operating system 112 at the same time as the monitoring application 114. As such monitoring application 114 may be executed independently, but concurrently, with the software application 120 that is to be monitored by the monitoring application 114.

The monitoring may be for the purpose of determining whether a user or operator has viewed or reviewed certain target data prior to a point of decision making, while using the software application 120. For example, the point of decision making may be related to the user signing off on an electronic document (e.g., invoice 150), where one or more fields (e.g., fields 1 through 3) are displayed in a user interface 115 rendered by the software application 120. Prior to making the decision, the user may be required to verify the value in said one or more fields (or certain other fields not currently displayed in the user interface 115) for the purpose of compliance.

For instance, consider a scenario where a user (e.g., a human operator) is using software application 120 (e.g., a billing app) to approve a bill by interacting with user interface 115 (e.g., by clicking an APPROVE button, marking a check box, or by way other interaction with user interface 115). Prior to the approval, it may be desirable to ensure that the user has viewed and considered, for example, three factors or conditions related to the bill. For example, the date of the bill should be within the past 3 months (Field 1), the biller should be on the list of approved providers (Field 2), and the amount of the bill should be less than an authorized threshold (Field 3).

In the above example, to determine whether the user has taken the requisite factors into consideration, monitoring application 114 is concurrently executed with software application 120, while the user is viewing or browsing different screens rendered by software application 120 (or the operating system 112 or other application). The monitoring application 114 may be initiated before or at the time software application 120 is started or at some point thereafter depending on implementation, the idea being that monitoring application 114 is independently executed, such that the monitoring effort is independent of the user's navigation path, while utilizing software application 120 to review the bill.

More particularly, in accordance with one exemplary embodiment, screen capture technology may be used as a part of the monitoring application 114 to determine what screens the operator is viewing while navigating through different screens rendered by software application 120. It is noteworthy that the monitoring application 114 may, but does not need to, rely on or require the operator to view any of the screens being rendered in any particular order. The monitoring application 114 can determine the screens that the operator is viewing by way of using screen capture technology, for example. That is, screen capture or other suitable technology may be used to determine, based on the screen or other programming attributes, which user interface, screen or functionality provided on the screen is being viewed or utilized, at any time, while software application 120 is being executed.

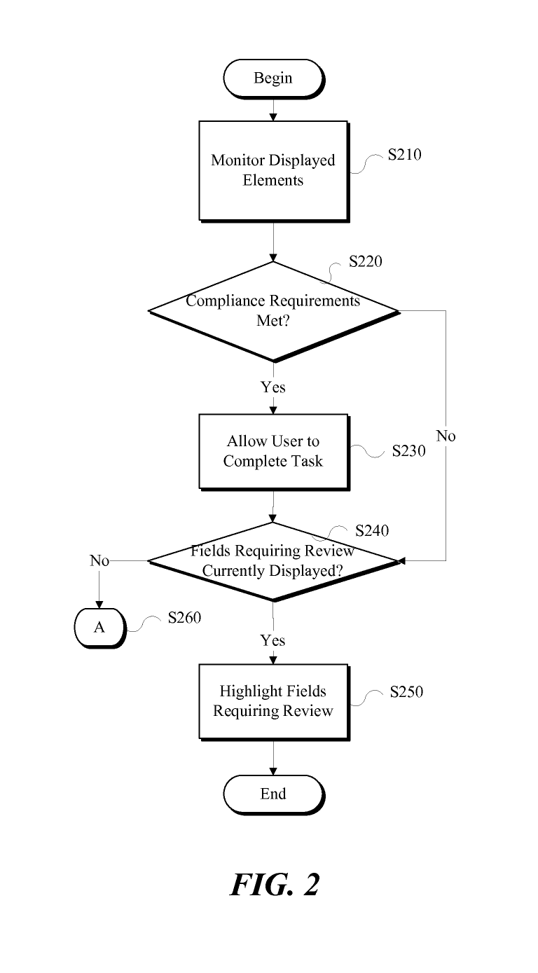

Referring to FIG. 2, in accordance with one embodiment, monitoring application 114 is executed concurrently with software application 120 to monitor displayed elements on user interface 115 (S210). The monitoring application 114 in addition to monitoring the displayed elements also determines at various points of decision making (or navigation steps), during the use of software application 120, whether one or more compliance requirements are met (S220). If so, then the monitoring application 114 will allow the user or the operator to make one or more decisions and complete the relevant tasks or navigate to the next navigation point (S230). Otherwise, it is determined whether the fields that require review are currently displayed in the user interface 115 (S240).

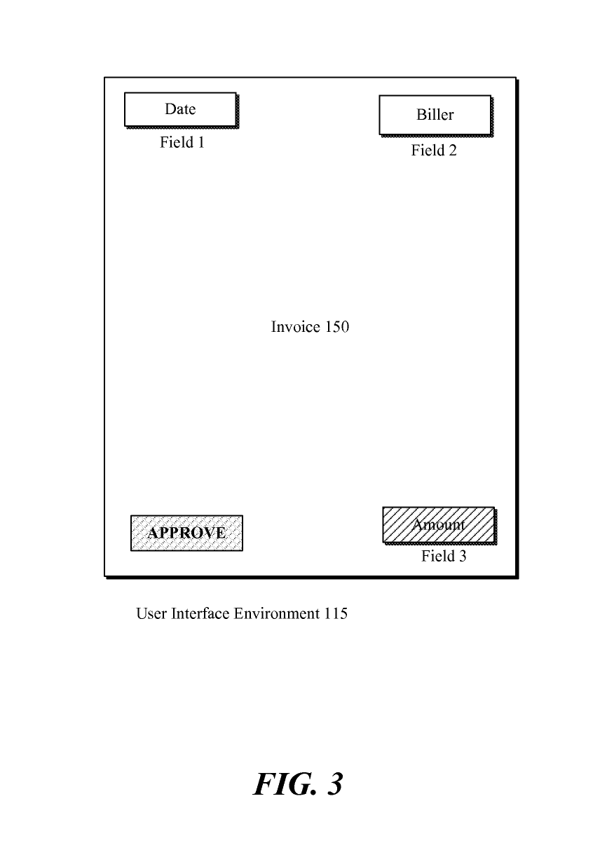

Referring to FIG. 3, for example, a screen in a billing application may include the date of the bill on the top left, the amount of the bill on the bottom right, and the name of the biller on the top right. Monitoring application 114 may be implemented to use screen capture to detect the particular screen being viewed by the user and (with or without some prior knowledge of the user interface attributes of software application 120) determine the location of the fields that are to include the values for the noted data on the screen. Further, the monitoring application 114 may provide an overlay on the screen to ubiquitously highlight the fields requiring review (S250) and alert the operator to areas that include the target information.

Depending on implementation, in one embodiment, the highlighting may be accomplished by way of color-coding, using pop-ups, bubbles, pointers, or other means that would help identify the target fields for review to a user. In the example shown in FIG. 3, areas of user interface 115 that include the date, amount and biller information may be highlighted. Without limitation, any highlighting scheme may be used to ubiquitously identify the fields that are to be reviewed for the purpose of compliance. In one example embodiment, an identifying marker or window may appear over the top right, bottom right and top left areas where fields 1 through 3 are displayed.

Once the target data or fields are identified on the user interface 115, then a mechanism such as a check box, or other means that require user interaction, either in an affirmative manner (e.g., a mouse-hover-over or mouse click on or about the identified area or field) or in a passive manner (e.g., viewing a screen for a certain time period) may be used to allow the user to confirm that the user has viewed the related data or fields. Referring back to FIG. 2, if fields requiring review are not currently displayed at the point of decision making, then other arrangements may be made (S260). Such arrangements may include monitoring application 114, optionally, navigating the user to a screen that displays the target fields, or preferably for monitoring application 114 to remain passive and let the user decide what is to be done next, so as not to force a predetermined navigation route upon the user.

As noted earlier, once all the related fields are confirmed as viewed or considered by the user, then the monitoring application 114 will allow the user to interact with software application 120, at the point of decision, to move on to the next step (e.g., the operator would be allowed to select the APPROVE button in the example shown in FIG. 3). Otherwise, monitoring application 114 would remind the user of the data or fields that are still in need of consideration and potentially would help the user to navigate to locations, screens, or areas where said data can be viewed.

It is noteworthy that in contrast to other monitoring applications which are internally embedded in a software application 120 that is being monitored, the independent nature of monitoring application 114 disclosed here allows the monitoring application 114 to monitor anything that appears on the screen. That is, in addition to software application 120, monitoring application 114 may be also implemented to monitor any other application that is running at the same time, giving the user freedom to browse or maneuver among different applications making it easier on the user to select his navigation path while monitoring application 114 still maintains a reference to the target application that is being monitored and the fields or data that need to be reviewed for the purpose of compliance.

Advantageously, if target field or data that are to be reviewed are not generated or controlled by the target application being monitored, then a second application other than the target application that may provide the needed information may be also monitored by monitoring application 114. For instance, in the above example, if the user needs to run a second application independent of the billing software that is being monitored to determine, for example, whether the biller is on the list of approved billers, then the monitoring application 114 may be also configured to monitor a second application that has control over the target data and apply same or similar scheme to highlight the related fields in the second application.

Accordingly, monitoring application 114 may be implemented to passively track and determine which screens are being viewed by a user (i.e., the screens may be rendered by one or more applications) and whether the user has confirmed that the related data have been considered by the user before allowing the user to move beyond a decision point.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

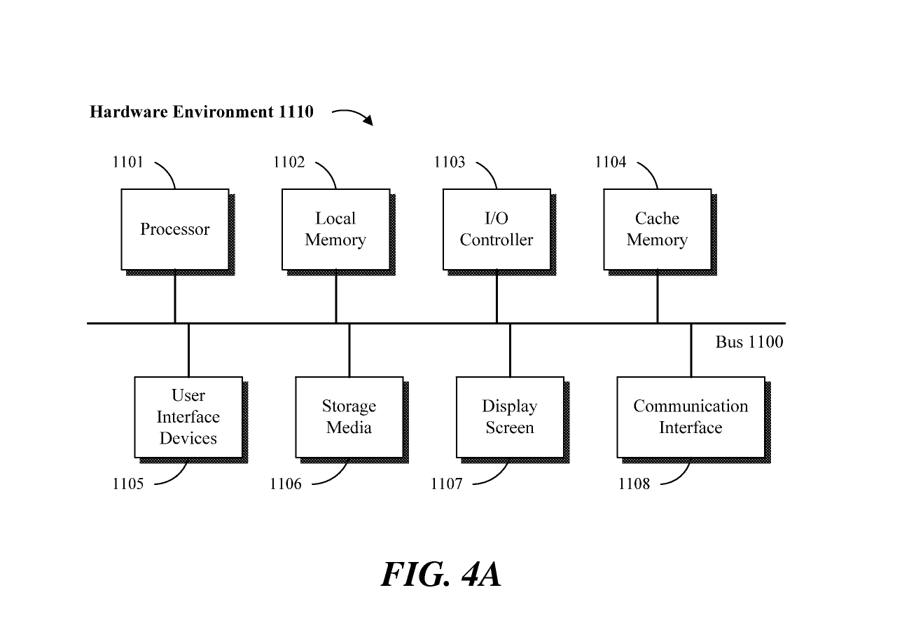

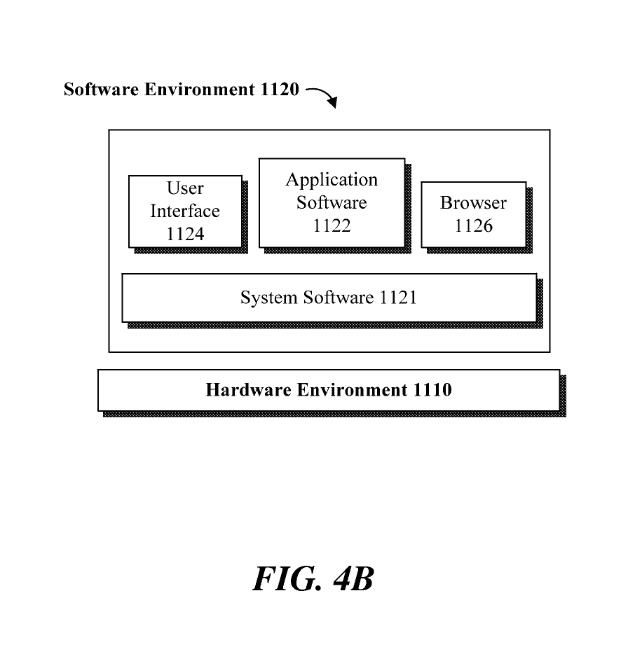

Referring to FIGS. 4A and 4B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 4A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for enforcing compliance in a computing environment, the method comprising:
concurrently and independently executing a monitoring application with a first application utilized by a user, wherein navigating beyond a first decision point in the first application requires the user considering values associated with one or more elements in the first application,
wherein the monitoring application monitors elements presented to the user to determine which elements are presented to the user at a point in time; and
notifying the user of at least a first element, in response to not having been able to confirm whether a value associated with the first element has been considered by the user prior to said first decision point.

2. The method of claim 1, wherein an element is a variable used to calculate an outcome when executing the first application.

3. The method of claim 1, wherein the first decision point is associated with approving an outcome based on the value associated with the first element.

4. The method of claim 1, wherein the elements are presented to the user via a user interface in a computing environment.

5. The method of claim 4, wherein the user interface is a display screen and the elements are monitored by the monitoring application by way of screen capture technology.

6. The method of claim 5, wherein the screen capture technology identifies the elements that are presented to the user at a point in time during execution of the first application.

7. The method of claim 6, wherein the notifying is performed by way of highlighting areas on the display screen for user's attention.

8. The method of claim 7, wherein the highlighting comprises ubiquitously displaying the first element to the user.

9. The method of claim 8, where the highlighting comprises at least one or more of color-coding, changing font attributes, or applying animation to visual aspects of the first element.

10. The method of claim 1 wherein the monitoring and the notifying does not interfere with the user's preference for navigation through the first application, and the user verifies that the user has considered the first element by way of interaction with a user interface.

11. A system for enforcing compliance in a computing environment, the system comprising:
a logic unit for concurrently and independently executing a monitoring application with a first application utilized by a user, wherein navigating beyond a first decision point in the first application requires the user considering values associated with one or more elements in the first application,
wherein the monitoring application monitors elements presented to the user to determine which elements are presented to the user at a point in time; and
a logic unit for notifying the user of at least a first element, in response to not having been able to confirm whether a value associated with the first element has been considered by the user prior to said first decision point.

12. The system of claim 11, wherein an element is a variable used to calculate an outcome when executing the first application.

13. The system of claim 11, wherein the first decision point is associated with approving an outcome based on the value associated with the first element.

14. The system of claim 11, wherein the elements are presented to the user via a user interface in a computing environment.

15. The system of claim 14, wherein the user interface is a display screen and the elements are monitored by the monitoring application by way of screen capture technology.

16. A computer program product comprising a data storage medium having a computer readable program, wherein the computer readable program when executed on a computer causes the computer to:
concurrently and independently execute a monitoring application with a first application utilized by a user, wherein navigating beyond a first decision point in the first application requires the user considering values associated with one or more elements in the first application,
wherein the monitoring application monitors elements presented to the user to determine which elements are presented to the user at a point in time; and
notify the user of at least a first element, in response to not having been able to confirm whether a value associated with the first element has been considered by the user prior to said first decision point.

17. The computer program product of claim 15, wherein an element is a variable used to calculate an outcome when executing the first application.

18. The computer program product of claim 17, wherein the first decision point is associated with approving an outcome based on the value associated with the first element.

19. The computer program product of claim 17, wherein the elements are presented to the user via a user interface in a computing environment.

20. The computer program product of claim 19, wherein the user interface is a display screen and the elements are monitored by the monitoring application by way of screen capture technology.
